(19) United States
(12) Patent Application Publication
(10) Pub. No.: US 2025/0135679 A1
(43) Pub. Date: May 1, 2025

(54) POSITIONING DEVICE FOR WOODWORKING MILLING MACHINE

(71) Applicant: SUPER POWER TOOLS CO., LTD., Taichung City (TW)

(72) Inventor: Yu-Chun LIU, Taichung City (TW)

(21) Appl. No.: 19/004,710

(22) Filed: Dec. 30, 2024

Related U.S. Application Data
(63) Continuation-in-part of application No. 18/447,140, filed on Aug. 9, 2023.

(51) Int. Cl. B27C 5/02; B27C 5/10

(52) U.S. Cl. CPC B27C 5/02; B27C 5/10

(57) ABSTRACT

Disclosed is a positioning device for a woodworking milling machine, which is designed to mount the machine on a track device. The positioning device has a mounting platform, a guide sleeve assembly, guide columns, a drive unit, and a lead screw. The mounting platform includes a base plate with a through hole slightly larger than the spindle head to allow the spindle head to pass through the through hole. The guide sleeve assembly is connected to the spindle head, while the guide columns are connected to the base plate and extend upwardly, pivotally passing through the guide sleeve assembly. The drive unit is connected to the mounting platform and drives the lead screw to rotate. The lead screw is parallel to the guide columns and threaded through the guide sleeve assembly to enable the guide sleeve assembly to move the spindle head vertically.

### CROSS-REFERENCE TO RELATED APPLICATIONS

The present invention is a continuation-in-part of U.S. application Ser. No. 18/447,140, filed Aug. 9, 2023, presently pending.

### FIELD OF THE INVENTION

The present invention relates to a positioning device for woodworking machinery, and more particularly to a positioning device for a woodworking milling machine, which is design to mount the milling machine on a track device, allowing it to move above a workpiece for top-down processing.

### BACKGROUND OF THE INVENTION

Woodworking milling machines, such as trimming machines and grooving machines, are commonly used for milling workpieces. These machines generally consist of a spindle head on which a milling cutter is mounted. The spindle head drives the milling cutter to rotate, enabling the workpiece to be milled. For ease of operation, the woodworking milling machine is also equipped with a support assembly that positions and stabilizes the spindle head.

The support assembly comprises a base, multiple columns, a guide sleeve assembly, and two Securing mechanisms. Each column is connected at one end to the base, which is formed with a through hole. The guide sleeve assembly is attached to a middle portion of the spindle head, with each column pivotally extending through the guide sleeve assembly. The Securing mechanisms are mounted on the guide sleeve assembly, each locking device laterally restraining the corresponding column. When the Securing mechanisms are released, the spindle head and the guide sleeve assembly are movable along the axial direction of the columns, thereby enabling the milling cutter to mill the workpiece positioned below the base.

In order to extend the application range of the woodworking milling machine, an extended application solution has been developed that allows the support assembly to be mounted on a track device. The track device comprises two first guide tracks, two second guide tracks, and a sliding seat. The first guide tracks are installed parallel to each other on a worktable that supports the workpiece. The second guide tracks are also parallel to each other, with each second guide track mounted above the corresponding first guide track, enabling the second guide tracks to move synchronously along the first guide tracks. The sliding seat is connected to the second guide track and includes a through hole, through which the milling cutter of the woodworking milling machine passes.

When the woodworking machine is mounted on the track device using the support assembly, the base is fixed to the sliding seat with multiple bolts, such that a mounting hole is aligned with the through hole. Operation of the support assembly causes the sliding seat to move along the second guide tracks, which in turn moves synchronously along the first guide tracks. This movement adjusts the milling path of the milling cutter on the workpiece, enabling trimming, grooving, surface planning, or cutting operations.

The spindle head can be equipped with milling cutters with different sizes and types, depending on the processing requirements. In order to accommodate the milling cutters with different diameters through both the mounting hole and the through hole, these holes are typically sized larger than the diameter of the largest milling cutter commonly used. Whilst this allows a variety of cutters to pass through, it often results in a gap between the hole walls and the circumference of the most cutters. This gap can cause milling powder and chips to scatter upward, reducing the operator's visibility. Additionally, when the woodworking milling machine is mounted on the sliding seat using the support assembly to enable downward movement of the milling cutter, the vertically arranged support assembly and sliding seat reduce the effective processing stroke for the workpiece.

### SUMMARY OF THE INVENTION

The main purpose of the present invention is to provide a positioning device for a woodworking milling machine.

In order to achieve the above purpose, the present invention adopts the following technical solution:

A positioning device for a woodworking milling machine, designed to mount the woodworking milling machine on a track device. The woodworking milling machine comprises a vertical spindle head and a milling cutter. The milling cutter is connected to and rotated by the spindle head, extending downwardly to process a workpiece positioned below the woodworking milling machine. The track device includes two first tracks and two second tracks. The first tracks are parallel to each other, as are the second tracks. Each second track is mounted above the corresponding first track, enabling the first tracks to guide the movement of the second tracks above the workpiece.

The positioning device comprises a mounting platform, including a base plate and two track engagement members. The base plate has a through hole, and each track engagement member is connected to the base plate. The track engagement members engage with and are guided by the second tracks, enabling the mounting platform to move back and forth along the second tracks.

A guide sleeve assembly is used to connect a middle portion of the spindle head along a vertical direction.

Multiple guide columns are each connected to the base plate, extending upwardly in parallel and pivotally passing through the guide sleeve assembly.

A drive unit is connected to the mounting platform.

A lead screw is connected to and rotated by the drive unit. The lead screw is positioned parallel to the guide columns and threaded through the guide sleeve assembly, enabling the guide sleeve assembly to move the spindle head vertically.

The portion of the spindle head adjacent to the milling cutter along the axial direction is referred to as a coupling portion. The outer diameter of the coupling portion is defined as a first diameter, while the inner diameter of the through hole is defined as a second diameter. The second diameter is slightly larger than the first diameter, allowing the coupling portion to pass through the through hole.

During operation, as the milling cutter processes the workpiece, the coupling portion can enter the through hole, forming a minimal gap between the circumference of the coupling portion and the wall of the through hole. The minimal gap reduces the likelihood of powder and chips generated during the milling of the workpiece being scattered upwardly, thereby minimizing obstruction of the operator's visibility. Furthermore, the positioning device eliminates the need to replace the mounting platform with through holes of different inner diameters to accommodate milling cutters of different radial dimensions, thereby improving operational efficiency and convenience.

### BRIEF DESCRIPTION OF DRAWINGS

FIG. 1 is a perspective view of a preferred embodiment of the present invention.

FIG. 2 is an upper-angle perspective view showing the preferred embodiment connected to the woodworking milling machine and mounted on the track device.

FIG. 3 is a partial lower-angle perspective view of the state shown in FIG. 2.

FIG. 4 is a partial sectional view showing the state of use of the preferred embodiment, displaying the woodworking milling machine before cutting the workpiece.

FIG. 5 is a partial sectional view showing the state of use of the preferred embodiment, displaying the woodworking milling machine cutting the workpiece.

FIG. 6 is an enlarged view of the area marked “6” in FIG. 5.

### DETAILED DESCRIPTION OF THE INVENTION

The drawings illustrate a preferred embodiment of the positioning device for a woodworking milling machine according to the present invention. It should be noted that the described embodiment is provided for illustrative purposes only and does not limit the scope of the patent application to the specific structures disclosed herein.

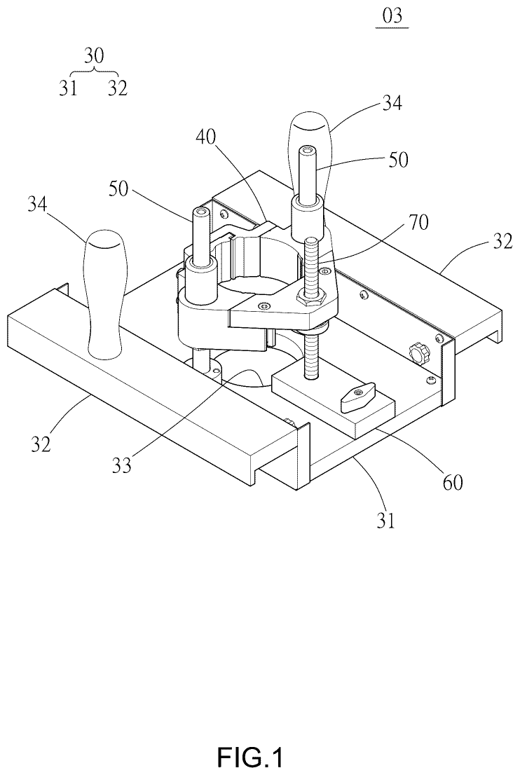

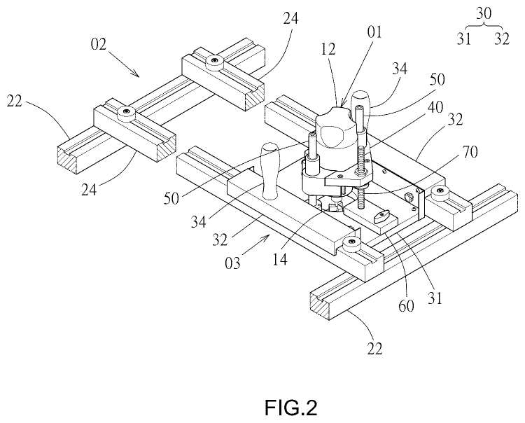

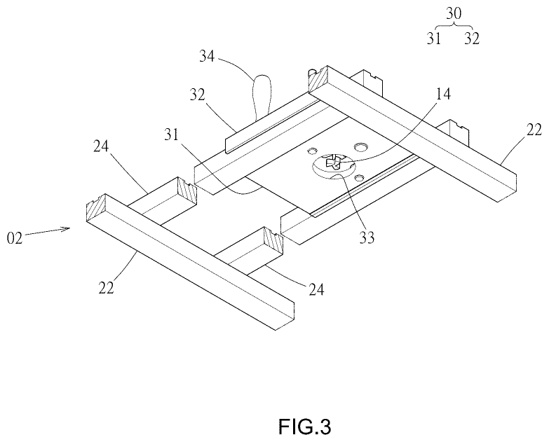

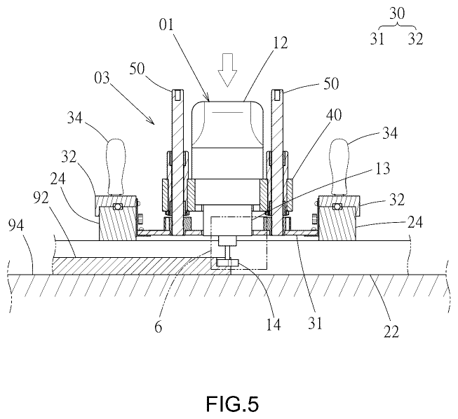

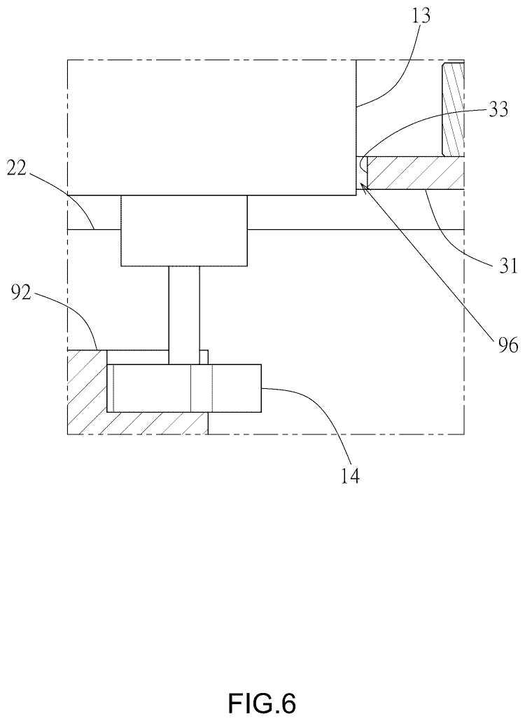

As shown in FIGS. 1 to 6, the preferred embodiment of the present invention is designed to mount a woodworking milling machine 01 on a track device 02. The woodworking milling machine 01 may be a trimming machine or a grooving machine and includes a vertical spindle head 12 and a milling cutter 14. The milling cutter 14 is operatively connected to the spindle head 12 and is driven to rotate by the spindle head 12. The milling cutter 14 extends downward to engage and process a workpiece 92 positioned below the woodworking milling machine 01. The track device 02 is mounted on the upper surface of a worktable 94, which provides support for the workpiece 92. The track device 02 comprises two first tracks 22 and two second tracks 24. The first tracks 22 are arranged parallel to each other, and the second tracks 24 are also parallel to each other. Each second track 24 is mounted above the corresponding first track 22, enabling the first tracks 22 to guide the movement of the second tracks 24 above the workpiece 92.

A positioning device 03 of the illustrated preferred embodiment comprises a mounting platform 30, a guide sleeve assembly 40, multiple guide columns 50, a drive unit 60, and a lead screw 70. The mounting platform 30 includes a base plate 31 and two track engagement members 32. The base plate 31 has a through hole 33, and each track engagement member 32 is connected to the base plate 31. Each track engagement member 32 is engaged with the respective second track 24, positioning the base plate 31 between the second tracks 24. The track engagement members 32 are guided by the second tracks 24, enabling the mounting platform 30 to move back and forth along the tracks.

The guide sleeve assembly 40 is used to connect a middle portion of the spindle head 12 in a vertical direction. The specific configuration of the guide sleeve assembly 40 is a prior art familiar to those skilled in the field, and therefore its detailed composition will not be described further.

Each guide column 50 is oriented vertically, with its lower end connected to the base plate 31. The guide columns 50 extend upwardly in parallel, with each passing pivotally through the guide sleeve assembly 40.

The drive unit 60 is connected to the mounting platform 30, and the lead screw 70 is connected to the drive unit 60. The lead screw 70 is rotated by the drive unit and is positioned parallel to the guide columns 50. The lead screw 70 threads through the guide sleeve assembly 40, enabling the guide sleeve assembly 40 to move the spindle head 12 vertically, raising or lowering it as needed.

The drive unit 60 may be configured as a power-driven device or, alternatively, as a manually operated transmission structure or a polygonal structure. Users may operate the transmission structure or the polygonal structure manually, or with tools to rotate the lead screw 70. The construction of such drive unit 60 is a prior art familiar to those skilled in the field, and therefore the specific composition of the drive unit 60 will also not be described further.

The portion of the spindle head 12 adjacent to the milling cutter 14 along the axial direction is referred to as a coupling portion 13. The outer diameter of the coupling portion 13 is defined as a first diameter ϕ1, while the inner diameter of the through hole 33 is defined as a second diameter ϕ2. The second diameter ϕ2 is slightly larger than the first diameter ϕ1 to allow the coupling portion 13 to pass through the through hole 33. Specifically, in the illustrated embodiment, the difference between the second diameter ϕ2 and the first diameter ϕ1 is between 5 mm and 15 mm.

The positioning device 03 is configured to position the woodworking milling machine 01 vertically on the track device 02. The drive unit 60 rotates the lead screw 70, which moves the spindle head 12 vertically via the guide sleeve assembly 40. As the spindle head 12 moves downward, the milling cutter 14 passes through the through hole 33 to mill the workpiece 92 supported on the upper surface of the worktable 94. In combination with the movement of the mounting platform 30 along the second tracks 24 and the synchronized movement of the second tracks 24 along the first tracks 22, the milling cutter 14 is capable of trimming or grooving the workpiece 92.

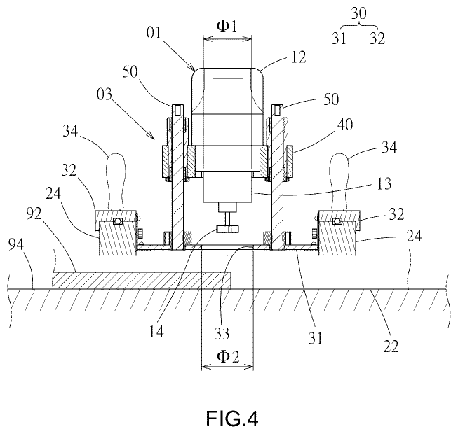

As shown in FIGS. 4, 5, and 6, since the second diameter ϕ2 is slightly larger than the first diameter ϕ1, the coupling portion 13 can enter the through hole 33 when the spindle head 12 descends and the milling cutter 14 processes the workpiece 92. This configuration forms a minimal gap 96 between the circumference of the coupling portion 13 and the wall of the through hole 33. The minimal gap 96 reduces the likelihood of powder and chips generated during the milling of the workpiece 92 being scattered upwardly, thereby minimizing obstruction of the operator's visibility.

In order to meet different processing requirements, the woodworking milling machine 01 might replace the milling cutter 14 with a cutter of a different size or shape. In such cases, the positioning device 03 does not require the replacement of the mounting platform 30 to provide through holes 33 with different inner diameters corresponding to the radial dimensions of the milling cutter 14. The space provided by the second diameter ϕ2, which is slightly larger than the first diameter ϕ1, still allows the coupling portion 13 to pass through the through hole 33. This configuration ensures that powder or chips continue to be prevented from scattering upwardly through the gap 96, thereby improving operational efficiency and convenience.

In contrast to the support assembly described in the prior art, which requires the base to be mounted on the sliding seat, the positioning device 03 mounts the woodworking milling machine 01 vertically on the track device 02. The mounting platform 30, which accommodates the guide columns 50 and the drive unit 60, is mounted directly on the second tracks 24, thus eliminating the need for the sliding seat configured on the track device 02. This arrangement reduces the vertical distance between the spindle head 12 and the workpiece 92 compared to the prior art. As a result, the positioning device 03 can provide a greater effective processing stroke for the workpiece 92 than the prior art configurations.

The mounting platform 30 is further equipped with two operating handles 34, each of which is attached to the respective track engagement member 32 and extends upward. These operating handles 34 allow users to grip them with both hands, facilitating easier operation and movement of the positioning device 03.

1. A positioning device for a woodworking milling machine, designed to mount the woodworking milling machine on a track device, wherein the woodworking milling machine comprises a vertical spindle head and a milling cutter, the milling cutter being connected to and rotated by the spindle head while extending downwardly to process a workpiece positioned below the woodworking milling machine; the track device comprising two first tracks and two second tracks, the first tracks being parallel to each other, and the second tracks also being parallel to each other, with the ends of each second track mounted above the corresponding first tracks to enable the first tracks to guide the movement of the second tracks above the workpiece;
the positioning device comprising:
a mounting platform, including a base plate and two track engagement members, wherein the base plate has a through hole, and each track engagement member is connected to the base plate, engages with the corresponding second track, and is guided by the second tracks to move, thereby enabling the mounting platform to move back and forth along the second tracks;
a guide sleeve assembly, used to connect a middle portion of the spindle head in a vertical direction;
multiple guide columns, each connected to the base plate, extending upwardly in parallel to each other, and each pivotally passing through the guide sleeve assembly;
a drive unit, connected to the mounting platform; and
a lead screw, connected to the drive unit and rotated by the drive unit, parallel to the guide columns and threaded through the guide sleeve assembly, thereby enabling the guide sleeve assembly to move the spindle head vertically;
wherein the portion of the spindle head adjacent to the milling cutter along the axial direction is referred to as a coupling portion, the outer diameter of the coupling portion is defined as a first diameter, while the inner diameter of the through hole is defined as a second diameter, and the second diameter is slightly larger than the first diameter to allow the coupling portion to pass through the through hole.

2. The positioning device for a woodworking milling machine according to claim 1, wherein the difference between the second diameter and the first diameter is between 5 mm and 15 mm.

3. The positioning device for a woodworking milling machine according to claim 1, wherein the mounting platform is equipped with two operating handles, each operating handle is attached to the respective track engagement member and extends upward.
